(19) United States
(12) Patent Application Publication
(10) Pub. No.: US 2015/0003134 A1
(43) Pub. Date: Jan. 1, 2015

(54) MODULAR MULTILEVEL CONVERTER USING ASYMMETRY

(71) Applicant: David Reginald Trainer, Alvaston (GB)

(72) Inventor: David Reginald Trainer, Alvaston (GB)

(73) Assignee: ALSTOM TECHNOLOGY LTD, Baden (CH)

(21) Appl. No.: 14/377,824

(22) PCT Filed: Feb. 16, 2012
(86) PCT No.: PCT/EP2012/052692

§ 371 Date: Aug. 8, 2014

(51) Int. Cl. H02M 7/49; H02J 3/36

(52) U.S. Cl. CPC H02M 7/49; H02J 3/36
USPC 363/132

(57) ABSTRACT

A power electronic converter assembly is provided having a multi-level converter, a plurality of phase elements and a controller to switch the multi-level converter. The multi-level converter includes a plurality of AC terminals and is operable to generate an AC phase voltage (V_{A}, V_{B}, V_{C}) at each AC terminal. The plurality of phase elements define a star connection in which a first end of each phase element is connected to a common junction. Each AC terminal is connected in series with a second end of a respective phase element of the star connection. The controller can switch the multi-level converter to modulate the plurality of AC phase voltages (V_{A}, V_{B}, V_{C}) to define a set of asymmetrical voltage vectors so as to synthesise a non-zero neutral point voltage at the common junction of the star connection, the non-zero neutral point voltage and each AC phase voltage (V_{A}, V_{B}, V_{C}) defining a line-to-neutral voltage across each phase element, the line-to-neutral voltages being equal in magnitude and displaced at equidistant phase angles.

This invention relates to a power electronic converter assembly.

In power transmission networks alternating current (AC) power is typically converted to direct current (DC) power for transmission via overhead lines and/or under-sea cables. This conversion removes the need to compensate for the AC capacitive load effects imposed by the transmission line or cable, and thereby reduces the cost per kilometer of the lines and/or cables. Conversion from AC to DC thus becomes cost-effective when power needs to be transmitted over a long distance.

The conversion of AC power to DC power is also utilized in power transmission networks where it is necessary to interconnect the AC networks operating at different frequencies.

In any such power transmission network, converters are required at each interface between AC and DC power to effect the required conversion, and one such form of converter is a voltage source converter (VSC).

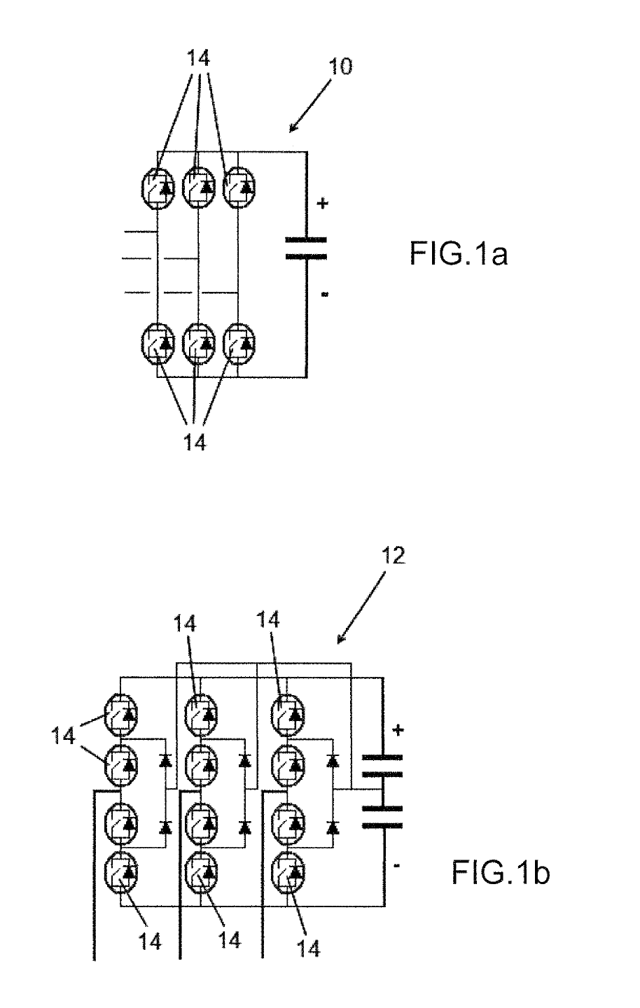

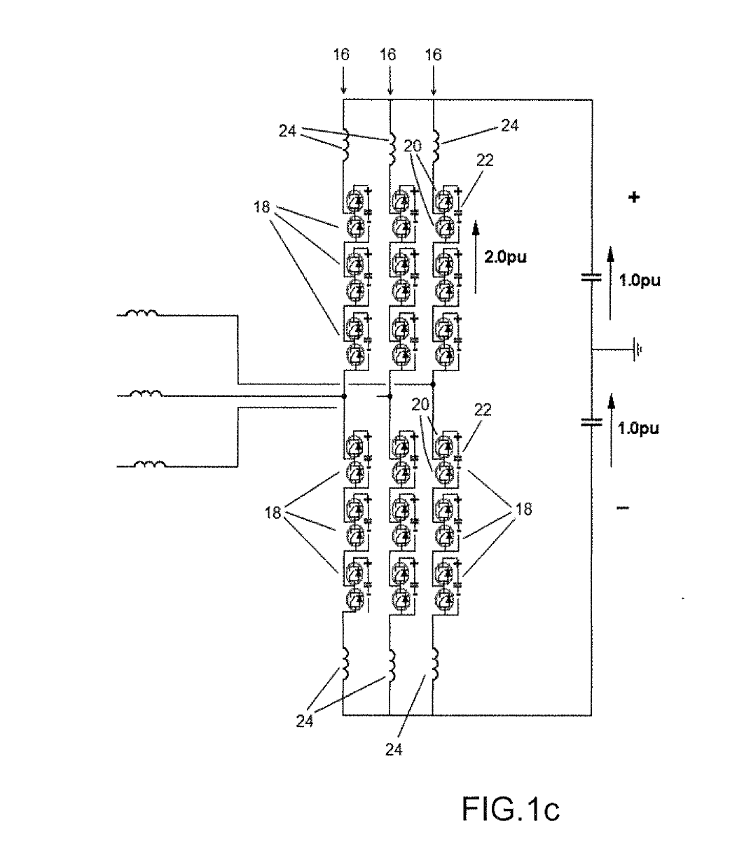

It is known in voltage source converters to use six-switch (two-level) and three-level converter topologies 10,12 with insulated gate bipolar transistors (IGBT) 14, as shown in FIGS. 1a and 1b. The IGBT devices 14 are connected and switched together in series to enable high power ratings of 10's to 100's of MW to be realized. In addition, the IGBT devices 14 switch on and off several times at high voltage over each cycle of the AC supply frequency to control the harmonic currents being fed to the AC network.

It is also known in voltage source converters to use a multi-level converter arrangement such as that shown in FIG. 1c. The multi-level converter arrangement includes respective converter bridges 16 of cells 18 connected in series. Each converter cell 18 includes a pair of series-connected insulated gate bipolar transistors (IGBTs) 20 connected in parallel with a capacitor 22. The individual converter cells 18 are not switched simultaneously and the converter voltage steps are comparatively small. The capacitor 22 of each converter cell 18 is configured to have a sufficiently high capacitive value in order to constrain the voltage variation at the capacitor terminals in such a multi-level converter arrangement. A DC side reactor 24 is also required in each converter bridge 16 to limit transient current flow between converter limbs, and thereby enable the parallel connection and operation of the converter limbs.

According to an aspect of the invention, there is provided a power electronic converter assembly comprising:

a multi-level converter including a plurality of AC terminals, the multi-level converter being operable to generate an AC phase voltage at each AC terminal;

a plurality of phase elements defining a star connection in which a first end of each phase element is connected to a common junction, each AC terminal being connected in series with a second end of a respective phase element of the star connection; and

a controller to switch the multi-level converter to modulate the plurality of AC phase voltages to define a set of asymmetrical voltage vectors so as to synthesise a non-zero neutral point voltage at the common junction of the star connection, the non-zero neutral point voltage and each AC phase voltage defining a line-to-neutral voltage across each phase element, the line-to-neutral voltages being equal in magnitude and displaced at equidistant phase angles.

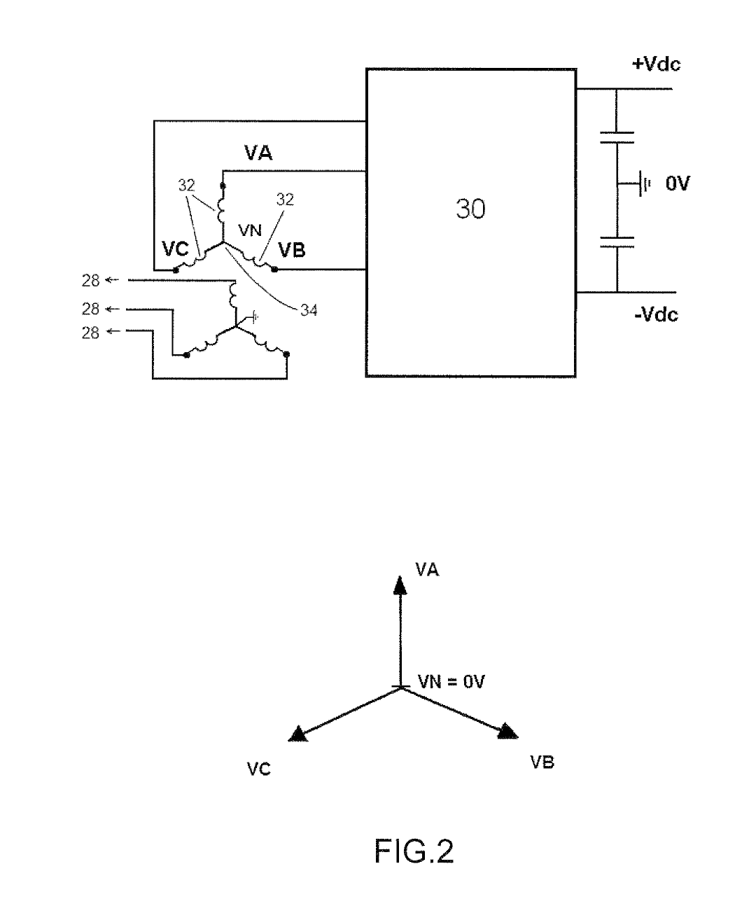

Conventionally, in order to enable connection to a multi-phase AC network 28, a voltage source converter 30 is configured to generate a plurality of AC phase voltages VA, VB, VC so as to synthesise a set of symmetrical voltage vectors that are equal in magnitude and displaced at equidistant phase angles. FIG. 2 shows the application of the symmetrical voltage vectors to a plurality of transformer secondary windings 32 arranged in the form of a star connection, which results in the formation of a zero neutral voltage VN at a common junction 34 of the star connection. Such synthesis of the set of symmetrical voltage vectors therefore enables the voltage source converter 30 to present a balanced multi-phase load/source for connection to the multi-phase AC network 28 via a transformer.

The inventor has however discovered that it is possible to modulate AC phase voltages to synthesise a set of asymmetrical voltage vectors in order to form a balanced multi-phase load/source for connection via a transformer to a multi-phase AC network or load.

For the purposes of this specification, the set of asymmetrical voltage vectors is defined as a plurality of voltage vectors, in which at least one voltage vector differs in magnitude and/or phase angle displacement relative to at least one other voltage vector.

The power electronic converter assembly may be configured for connection via a transformer to a multi-phase AC network or load having more than three, four, five or more AC phases. In such a configuration, the number of AC terminals and the number of phase elements in the power electronic converter assembly correspond to the number of AC phases in the multi-phase AC network or load, and the neutral point voltage at the common junction of the star connection is equal to the sum of the individual AC phase voltages divided by the number of AC phases.

In use, the multi-level converter in the power electronic converter assembly according to the invention is switched using the controller to modulate each AC phase voltage, i.e. control the waveform characteristics of each AC phase voltage, to define a set of asymmetrical voltage vectors. The magnitude and phase angle displacement of each asymmetrical voltage vector is configured so as to synthesise a non-zero neutral point voltage at the common junction of the star connection and a line-to-neutral voltage across each phase element that is equal in magnitude and displaced at equidistant phase angles to the other line-to-neutral voltages. This results in a set of symmetrical line-to-neutral voltages, which may be used to present a balanced multi-phase load/source for connection to the multi-phase AC network or load.

Configuration of the power electronic converter assembly to enable modulation of the AC phase voltages in this manner is exemplified in an embodiment of the invention, wherein the multi-level converter includes three AC terminals; and the controller switches the multi-level converter to modulate each AC phase voltage to generate: a first, sinusoidal AC phase voltage with an amplitude of 1.732 per unit voltage and a phase angle of zero degrees; a second, sinusoidal AC phase voltage with an amplitude of 1.0 per unit voltage and a phase angle of 90 degrees; and a third, sinusoidal AC phase voltage with an amplitude of 1.0 per unit voltage and a phase angle of −90 degrees.

Switching of the multi-level converter in this manner results in a sinusoidal, neutral point voltage with an amplitude of 0.577 per unit voltage and a phase angle of zero degrees, and thereby three sinusoidal, line-to-neutral voltages, each of which has an amplitude of 1.155 per unit voltage and a phase angle of 120 degrees. The symmetrical line-to-neutral voltages may therefore be used to present a balanced three-phase load/source for connection to a three-phase AC network or load.

Other sets of asymmetrical voltage vectors may be defined so as to synthesise the non-zero neutral point voltage and symmetrical line-to-neutral voltages. This is achieved by varying the magnitude and/or phase angle displacement of each asymmetrical voltage vector to shift the ground reference point relative to each voltage vector.

The asymmetrical nature of the set of voltage vectors synthesised using the power electronic converter assembly means that required power ratings for generating the respective AC phase voltages differs between at least two of the AC phase voltages, i.e. a required power rating for generating one of the AC phase voltages is at least lower than a required power rating for generating another of the AC phase voltages. This permits optimisation of the structure of the multi-level converter in order to reduce the number of converter components in the multi-level converter whilst achieving the aforementioned required power ratings. This has the benefits of decreasing the overall size, weight and cost, and improving the reliability and efficiency, of the power electronic converter assembly.

In contrast, modulation of the AC phase voltages to define a set of symmetrical voltage vectors would require identical power ratings for generating the respective AC phase voltages. It therefore becomes difficult to optimise the configuration of the multi-level converter in order to reduce the number of converter components in the multi-level converter whilst achieving the aforementioned required power ratings.

In addition, the ability to optimise the configuration of the multi-level converter provides flexibility in designing the power electronic converter assembly for use in locations having different power and weight requirements, space envelope properties and availability of converter components.

The multi-level converter may be configured in different ways to enable modulation of the AC phase voltages to synthesise the non-zero neutral point voltage at the common junction of the star connection, so that the line-to-neutral voltage across each phase element is equal in magnitude and displaced at equidistant phase angles to the other line-to-neutral voltages.

In embodiments of the invention, the multi-level converter may further include:

first and second DC terminals for connection to a DC network, the multi-level converter being operable to generate a DC voltage at the first and second DC terminals; and

a plurality of converter limbs, each converter limb extending between the first and second DC terminals and including a respective one of the AC terminals, the plurality of converter limbs including at least one primary converter limb and at least one secondary converter limb, each converter limb including first and second limb portions separated by the corresponding AC terminal, each limb portion of the primary converter limb including a primary voltage source and each limb portion of each secondary converter limb including a secondary voltage source.

In such embodiments, each limb portion of the or each primary converter limb may further include a primary switching block connected in series with the corresponding voltage source, and each limb portion of the or each secondary converter limb may further include a secondary switching block connected in series with the corresponding voltage source.

The use of the primary and secondary voltage sources allows each limb portion to provide a voltage to offset the DC voltage at the first or second DC terminal in order to provide a varying voltage at the corresponding AC terminal.

Each converter limb operates independently of the other converter limbs and therefore only directly affects the phase connected to the respective AC terminal. As such, the structure of each of the primary and secondary converter limbs may be separately optimised with respect to the AC phase voltage at the corresponding AC terminal, with minimal disruption to the AC phase voltage connected to the other AC terminals.

The use of a switching block in each limb portion allows each limb portion to be switched into or out of circuit at zero current and/or zero voltage, i.e. soft switching, which results in almost zero switching losses during operation of the power electronic converter assembly. In addition, the use of the switching block in each limb portion reduces the voltage range that each voltage source would be required to generate. This in turn allows the number of components in each voltage source to be minimized.

In other embodiments of the invention, the multi-level converter may further include:

first and second DC terminals for connection to a DC network, the multi-level converter being operable to generate a DC voltage at the first and second DC terminals; and

a plurality of converter limbs, each converter limb extending between the first and second DC terminals and including a respective one of the AC terminals, the plurality of converter limbs including a primary converter limb and two secondary converter limbs, the secondary converter limbs being connected in parallel between the first and second DC terminals, each converter limb including first and second limb portions separated by the corresponding AC terminal, each limb portion of the primary converter limb including a primary voltage source and each limb portion of each secondary converter limb including a secondary switching block; and

two secondary voltage sources, each secondary voltage source extending between: the parallel connection of the secondary converter limbs; and a respective one of the first and second DC terminals.

The configuration of the multi-level converter in this manner further reduces the overall number of voltage sources, which enables further savings in terms of overall size, weight and cost of the power electronic converter assembly, without affecting the capability of the multi-level converter to synthesise a set of asymmetrical voltage vectors that results in a balanced load/source for presentation to a multi-phase AC network.

In further embodiments of the invention, the multi-level converter may further include:

a plurality of auxiliary terminals, each auxiliary terminal being for connection to ground; and

a plurality of converter limbs, each converter limb including a respective one of the auxiliary terminals and a respective one of the AC terminals, each converter limb extending between its auxiliary terminal and its AC terminal,

wherein the plurality of converter limbs includes a primary converter limb and two secondary converter limbs, each primary converter limb including a primary voltage source and each secondary converter limb including a secondary voltage source.

The configuration of the power electronic converter assembly in this manner permits the power electronic converter assembly to be used as a static synchronous compensator.

In embodiments employing the use of voltage sources, each primary voltage source may be or may include a bidirectional voltage sub-source and/or the or each secondary voltage source may be or may include a bidirectional voltage sub-source.

The ability to provide a bidirectional voltage allows the corresponding limb portion to modulate the AC phase voltage to have an amplitude that exceeds the DC voltage at the first or second DC terminal. This in turn provides the corresponding converter limb with additional flexibility when it comes to synthesising a voltage vector with a different magnitude to the voltage vectors synthesised by the other converter limbs so as to result in the above-described set of asymmetrical voltage vectors.

Moreover, in the event of a fault in the DC network resulting in high fault current in the multi-level converter, each bidirectional voltage sub-source may be controlled to provide a voltage which opposes the driving voltage of the AC network and thereby reduces the fault current in the power electronic converter assembly. Each bidirectional voltage sub-source is capable of providing a positive or negative opposing voltage and is thereby suitable to oppose an AC driving voltage.

In embodiments employing the use of secondary voltage sources, each secondary voltage source may be or may include a unidirectional voltage sub-source.

The multi-level converter may be configured to modulate the AC phase voltages to synthesise the set of asymmetrical voltage vectors so as to permit the use of one or more unidirectional voltage sub-sources having a smaller voltage range and a reduced number of components in comparison to, for example, a bidirectional voltage sub-source.

Preferably each voltage sub-source includes at least one module, the or each module including: at least one energy storage device; and at least one switching element to selectively direct current through the or each energy storage device and cause current to bypass the or each energy storage device.

Each bidirectional voltage sub-source may include at least one first module, the or each first module including two pairs of switching elements connected in parallel with an energy storage device in a full-bridge arrangement to define a 4-quadrant bipolar module that can provide negative, zero or positive voltage and can conduct current in two directions.

Each unidirectional voltage sub-source may include at least one second module, the or each second module including a pair of switching elements connected in parallel with an energy storage device in a half-bridge arrangement to define a 2-quadrant unipolar module that can provide zero or positive voltage and can conduct current in two directions.

Such modules provide a reliable means of providing a voltage source to generate and modulate an AC phase voltage at each AC terminal.

In particular, when a voltage sub-source includes a plurality of modules, it is possible to build up a combined voltage across the voltage sub-source, which is higher than the voltage available from each of its individual modules, via the insertion of the energy storage devices of multiple modules, each providing its own voltage, into the voltage sub-source. This in turn allows the voltage sub-source to provide a stepped variable voltage sub-source, which permits the generation of a voltage waveform across the voltage sub-source using a step-wise approximation.

In other embodiments of the invention, the multi-level converter may be or may include a neutral point diode clamped converter or a flying capacitor converter.

The power electronic converter assembly is applicable, but not limited, to HVDC power transmission and reactive power compensation and static synchronous compensator applications.

Preferred embodiments of the invention will now be described, by way of non-limiting examples, with reference to the accompanying drawings in which:

FIGS. 1a, 1b and 1c show, in schematic form, prior art voltage source converters;

FIG. 2 illustrates the operation of a conventional voltage source converter to synthesise a set of symmetrical voltage vectors;

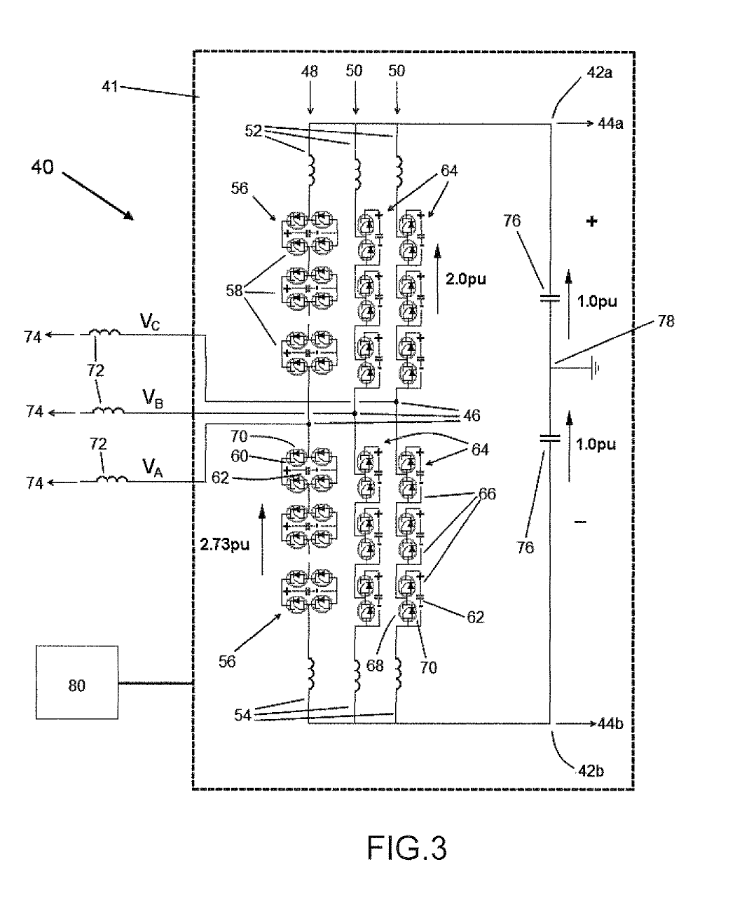

FIG. 3 shows, in schematic form, a power electronic converter assembly according to a first embodiment of the invention;

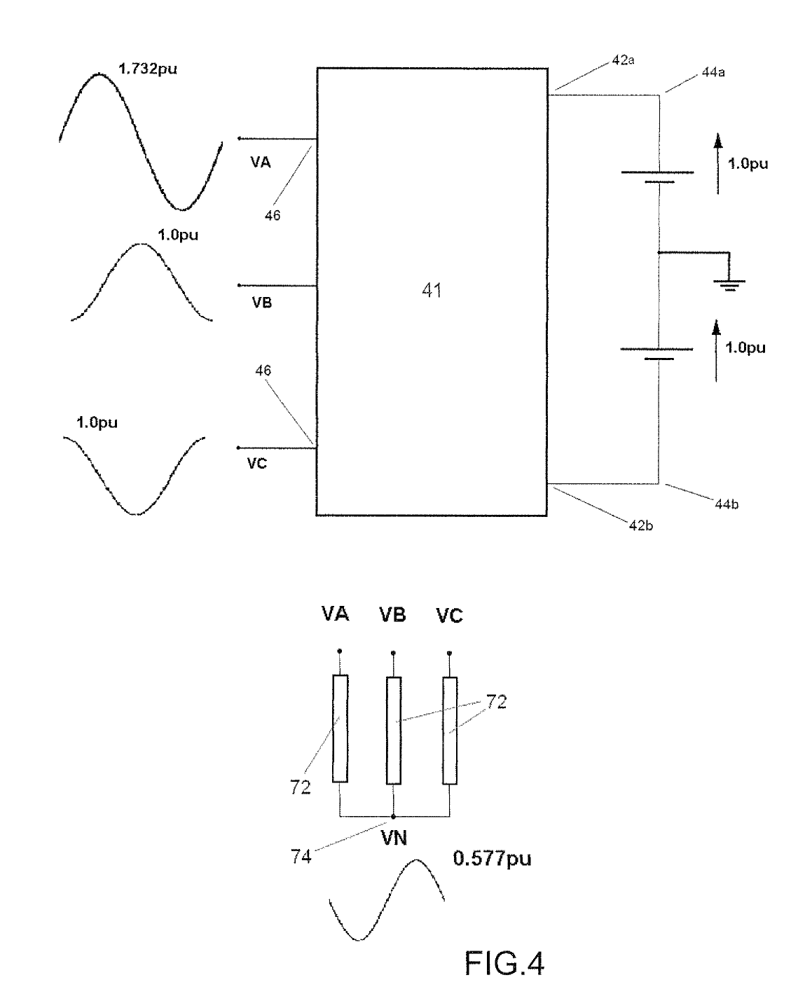

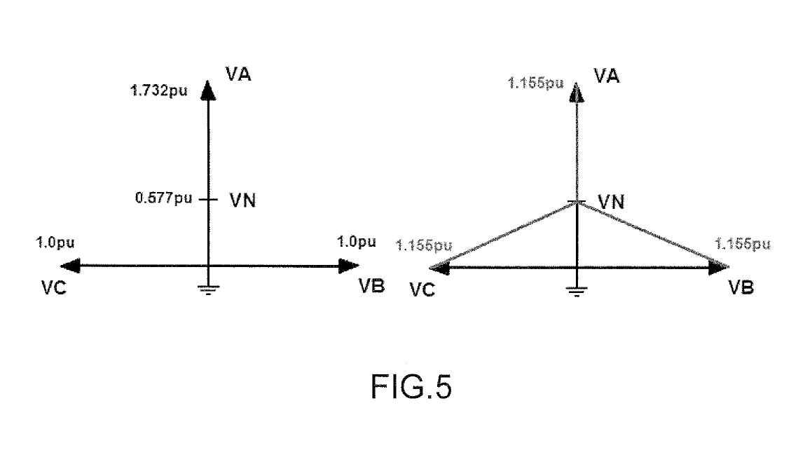

FIGS. 4 and 5 illustrate the operation of the power electronic converter assembly shown in FIG. 3 to synthesise a set of asymmetrical voltage vectors;

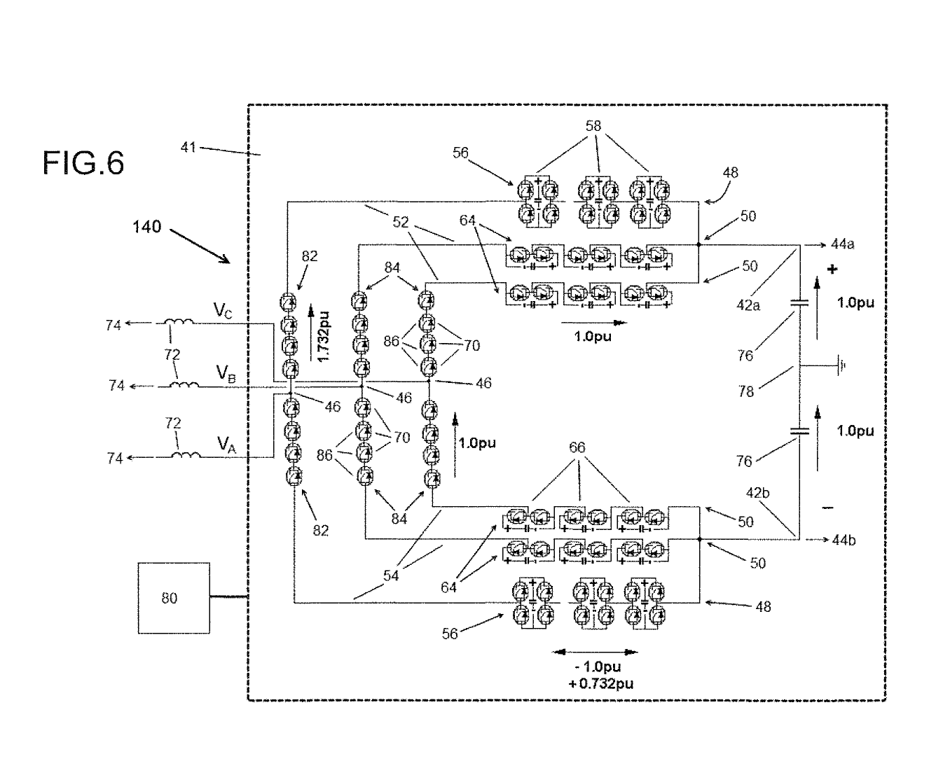

FIG. 6 shows, in schematic form, a power electronic converter assembly according to a second embodiment of the invention;

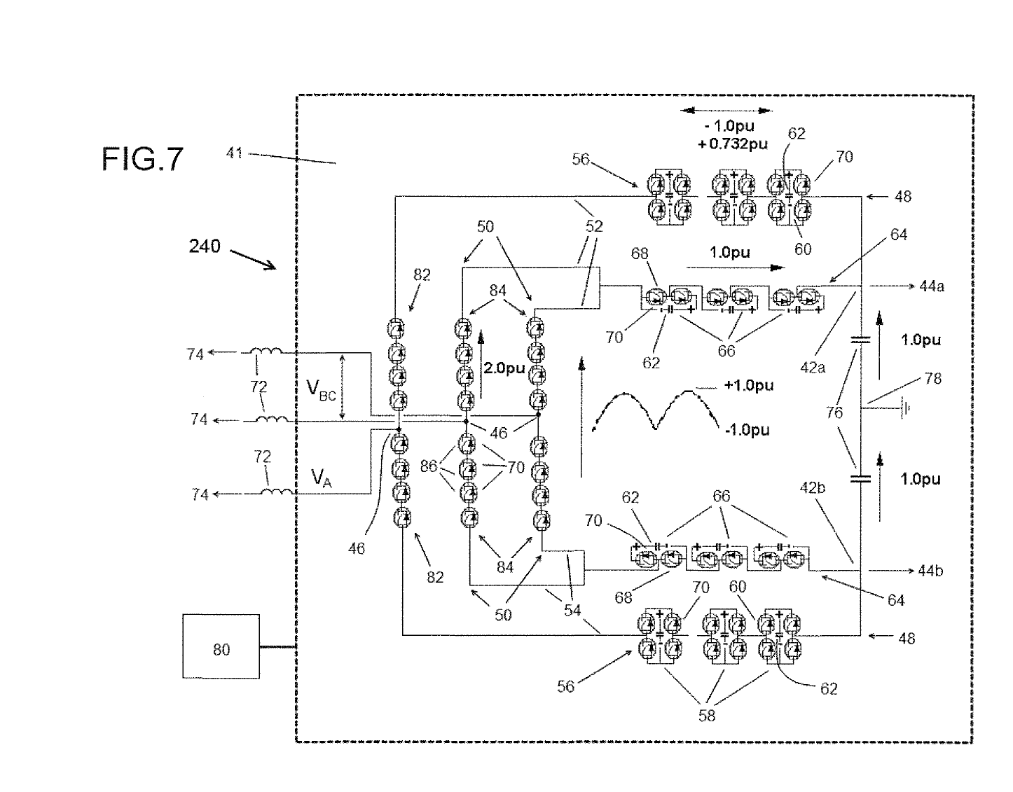

FIG. 7 shows, in schematic form, power electronic converter assembly according to a third embodiment of the invention;

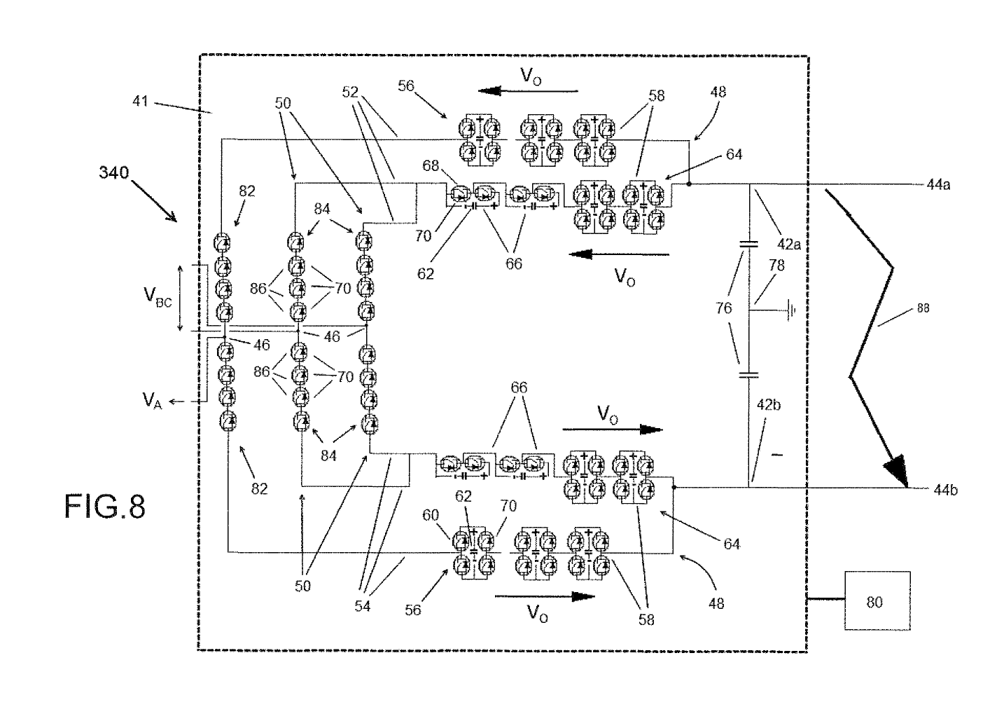

FIG. 8 shows, in schematic form, a power electronic converter assembly according to a fourth embodiment of the invention;

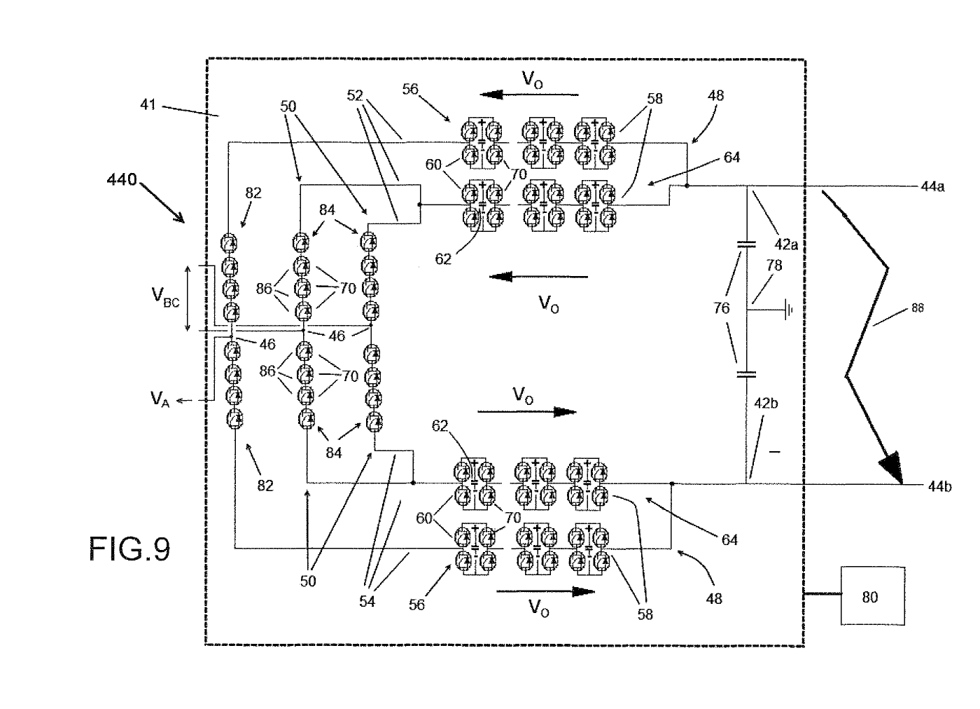

FIG. 9 shows, in schematic form, a power electronic converter assembly according to a fifth embodiment of the invention; and

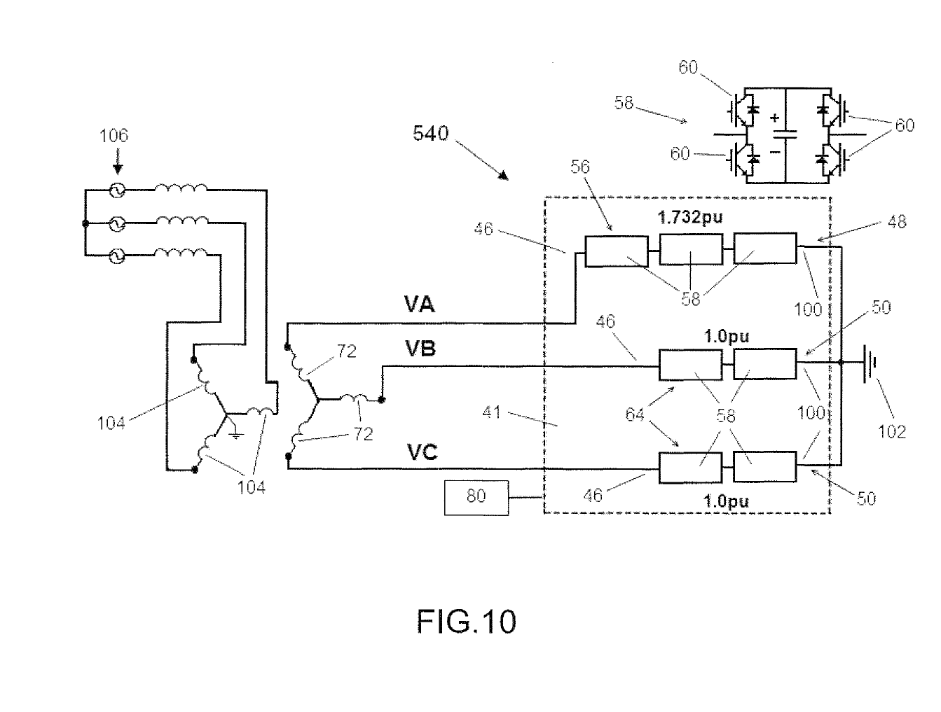

FIG. 10 shows, in schematic form, a power electronic converter assembly according to a sixth embodiment of the invention.

A power electronic converter assembly 40 according to a first embodiment of the invention is shown in FIGS. 3 and 4.

The first power electronic converter assembly 40 comprises a multi-level converter 41 including first and second DC terminals 42a,42b, and three AC terminals 46.

In use, the first and second DC terminals 42a,42b are respectively connected to positive and negative terminals 44a,44b of a DC network, in which the positive terminal 44a is at a voltage of +1.0 per unit voltage and the negative terminal 44b is at a voltage of −1.0 per unit voltage.

The multi-level converter 41 further includes a primary converter limb 48 and two secondary converter limbs 50. Each converter limb 48,50 extends between the first and second DC terminals 42a,42b. Each converter limb 48,50 includes a respective one of the AC terminals 46, and first and second limb portions 52,54 separated by the corresponding AC terminal 46.

Each limb portion 52,54 of the primary converter limb 48,50 includes a primary voltage source 56 in the form of a bidirectional voltage sub-source.

Each bidirectional voltage sub-source includes a plurality of first modules 58. Each first module 58 includes two pairs of first switching elements 60 connected in parallel with an energy storage device in the form of a capacitor 62. The two pairs of first switching elements 60 and the capacitor 62 are connected in a full-bridge arrangement to define a 4-quadrant bipolar module 58 that can provide negative, zero or positive voltage and can conduct current in two directions.

The capacitor 62 of each 4-quadrant bipolar module 58 is selectively bypassed or inserted into each corresponding voltage source 56 by changing the state of the first switching elements 60 of each corresponding 4-quadrant bipolar module 58.

In particular, the capacitor 62 of each 4-quadrant bipolar module 58 is bypassed when the pairs of first switching elements 60 in each 4-quadrant bipolar module 58 are configured to form a short circuit in the 4-quadrant bipolar module 58. This causes the current in the power electronic converter assembly 40 to pass through the short circuit and bypass the capacitor 62, and so the 4-quadrant bipolar module 58 provides a zero voltage.

The capacitor 62 of each 4-quadrant bipolar module 58 is inserted into each corresponding voltage source 56 when the pairs of first switching elements 60 in each 4-quadrant bipolar module 58 are configured to allow the converter current to flow into and out of the capacitor 62. The capacitor 62 then charges or discharges its stored energy so as to provide a voltage. The bidirectional nature of the 4-quadrant bipolar module 58 means that the capacitor 62 may be inserted into the 4-quadrant bipolar module 58 in either forward or reverse directions so as to provide a positive or negative voltage.

Each limb portion 52,54 of each secondary converter limb 50 includes a secondary voltage source 64 in the form of a unidirectional voltage sub-source.

Each unidirectional voltage sub-source includes a plurality of second modules 66. Each second module 66 includes a pair of second switching elements 68 connected in parallel with an energy storage device in the form of a capacitor 62. The pair of second switching elements 68 and the capacitor 62 are connected in a half-bridge arrangement to define a 2-quadrant unipolar module 66 that can provide zero or positive voltage and can conduct current in two directions.

In a similar fashion to that of the 4-quadrant bipolar module 58, the capacitor 62 of each 2-quadrant unipolar module 66 is selectively bypassed or inserted into each corresponding voltage source 64 by changing the state of the secondary switching elements of each corresponding 2-quadrant unipolar module 66. This selectively directs current through the corresponding capacitor 62 or causes current to bypass the corresponding capacitor 62, so that each 2-quadrant unipolar module 66 provides a zero or positive voltage.

Each primary voltage source 56 is configured to have a voltage rating of 2.732 per unit voltage, while each secondary voltage source 64 is configured to have a voltage rating of 2.0 per unit voltage.

Each of the first and second switching elements 60,68 is constituted by a semiconductor device in the form of an Insulated Gate Bipolar Transistor (IGBT). Each of the first and second switching elements 68 also includes an anti-parallel diode 70 connected in parallel therewith.

In other embodiments of the invention (not shown), it is envisaged that one or more switching elements may be a different semiconductor device such as a gate turn-off thyristor, a field effect transistor, an insulated gate commutated thyristor, an injection-enhanced gate transistor, an integrated gate commutated thyristor or any other self-commutated semiconductor device. In each instance, the semiconductor device is preferably connected in parallel with an anti-parallel diode.

It is envisaged that, in other embodiments of the invention (not shown), the capacitor in each module may be replaced by a different energy storage device such as a fuel cell, a battery or any other energy storage device capable of storing and releasing its electrical energy to provide a voltage.

The plurality of modules 58,66 in each voltage source 56,64 defines a chain-link converter. It is possible to build up a combined voltage across each chain-link converter, which is higher than the voltage available from each of its individual modules 58,66, via the insertion of the capacitors 62 of multiple modules 58,66, each providing its own voltage, into each chain-link converter.

In this manner switching of the switching elements 60,68 of each module 58,66 causes each voltage source 56,64 to provide a stepped variable voltage source, which permits the generation of a voltage waveform across each voltage source 56,64 using a step-wise approximation.

The power electronic converter assembly 40 further includes three phase elements 72 defining a star connection, as shown in FIG. 4. A first end of each phase element 72 is connected to a common junction 74 of the star connection, while each AC terminal 46 is connected in series with a second end of a respective phase element 72 of the star connection. Each phase element 72 is in the form of a transformer secondary winding.

In use, each phase element 72 is coupled to a respective transformer primary winding (not shown), and the plurality of transformer primary windings are connected in a star configuration for connection to a three-phase AC network (not shown).

The multi-level converter 41 further includes a pair of DC link capacitors 76 connected in series between the first and second DC terminals 42a,42b and in parallel with each converter limb 48,50. A mid-point 78 between the DC link capacitors 76 define a junction for connection in use to ground. Each DC link capacitor 76 has a voltage rating of 1.0 per unit voltage.

The power electronic converter assembly 40 further includes a controller 80 to switch the multi-level converter 41 to generate and modulate an AC phase voltage at each AC terminal 46.

In particular, in the embodiment shown, the controller 80 varies the timing of the switching operations of the modules 58,66 in each voltage source 56,64 to generate a AC phase voltage VA, VB, VC at each corresponding AC terminal 46 using a step-wise approximation.

Moreover the ability of the voltage sources 56,64 to provide voltage steps, as set out above, allows them to increase or decrease the voltage generated at each corresponding primary AC terminal 46.

In use, the controller 80 is therefore able to selectively switch the IGBTs 60,68 in each voltage source 56,64 to vary the voltage across each voltage source 56,64 and thereby modulate the AC phase voltage VA, VB, VC at each corresponding primary AC terminal 46.

Operation of the first power electronic converter assembly 40 is described as follows with reference to FIGS. 3 to 5.

To generate a first AC phase voltage VA at the AC terminal 46 of the primary converter limb 48, the controller 80 switches the first modules 58 in the first limb portion 52 of the primary converter limb 48 to add and subtract voltage steps to/from, i.e. “push up” and “pull down” against, the DC voltage at the first DC terminal 42a, and selectively switches the first modules 58 in the second limb portion 54 of the primary converter limb 48 to add and subtract voltage steps to/from the DC voltage at the second DC terminal 42b.

In this manner, the first modules 58 in the primary converter limb 48 are switched to generate a first, sinusoidal AC phase voltage VA with an amplitude of 1.732 per unit voltage and a phase angle of zero degrees.

To generate second and third AC phase voltages VB, VC at the AC terminals 46 of the secondary converter limbs 50, the controller 80 switches the second modules 66 in the first limb portions 52 of each secondary converter limb 50 to subtract voltage steps from, i.e. “pull down” against, the DC voltage at the first DC terminal 42a, and selectively switches the second modules 66 in the second limb portions 54 of each secondary converter limb 50 to add voltage steps to the DC voltage at the second DC terminal 42b.

In this manner, the second modules 66 in each secondary converter limb 50 are switched to generate a second, sinusoidal AC phase voltage VB with an amplitude of 1.0 per unit voltage and a phase angle of 90 degrees; and a third, sinusoidal AC phase voltage VC with an amplitude of 1.0 per unit voltage and a phase angle of −90 degrees.

The three AC phase voltages VA, VB, VC define a set of asymmetrical voltage vectors, which results in the formation of a non-zero neutral point voltage VN at the common junction 74 of the star connection. The neutral point voltage VN is equal to the sum of the individual AC phase voltages VA, VB, VC divided by the number of AC phases, i.e. three.

The non-zero neutral point voltage VN is sinusoidal in shape, and has an amplitude of 0.577 per unit voltage and a phase angle of zero degrees. In turn, the non-zero neutral point voltage VN and each AC phase voltage VA, VB, VC on either side of each phase element 72 define a line-to-neutral voltage VAN, VBN, VCN across each phase element 72.

FIG. 5 illustrates the relationship between the above-described set of asymmetrical voltage vectors VA, VB, VC, and the resulting non-zero neutral point voltage VN and line-to-neutral voltages VAN, VBN, VCN.

Each line-to-neutral voltage VAN, VBN, VCN has a magnitude of 1.155 per unit voltage and is separated by 120 electrical degrees from the other two line-to-neutral voltages VAN, VBN, VCN. These symmetrical line-to-neutral voltage characteristics therefore enable the power electronic converter assembly 40 to present a balanced load/source for connection to the three-phase AC network via the transformer primary windings.

In use, the controller 80 may switch the modules 58,66 in the primary and secondary converter limbs 48,50 to define different sets of asymmetrical voltage vectors to the set outline above, which results in a non-zero neutral point voltage and symmetrical line-to-neutral voltages. This is achieved by varying the magnitude and/or phase angle displacement of each asymmetrical voltage vector and thereby shift the ground reference point relative to each voltage vector.

The operation of the first power electronic converter assembly 40 in this manner is advantageous in that it permits optimisation of the structure of the multi-level converter 41 in order to minimise the number of converter components in the multi-level converter 41.

In particular, the capability of the primary converter limb 48 to modulate the first AC phase voltage VA to have an amplitude that exceeds the DC voltage at the first or second DC terminal 42a,42b allows the secondary converter limbs 50 to rely on the use of unidirectional voltage sub-sources to generate the second and third AC phase voltages VB, VC. The smaller voltage range and reduced number of components of each unidirectional voltage sub-source, when compared to each bidirectional voltage sub-source, minimises the overall size, weight and cost, and increasing the reliability and efficiency, of the first power electronic converter assembly 40.

In contrast, generation of a set of symmetrical voltage vectors with a magnitude of 1.155 per unit voltage each would require the inclusion of bidirectional voltage sub-sources in each secondary converter limb 50 so as to enable generation of second and third AC phase voltages with amplitudes exceeding the DC voltage at the first or second DC terminal 42a,42b. The use of bidirectional voltage sub-sources in the secondary converter limbs 50 would however increase the overall number of switching elements 60 and capacitors 62.

Thus, for a given power rating of the AC network, the configuration of the first power electronic converter assembly 40 to enable generation of the above-described set of asymmetrical voltage vectors therefore permits optimisation of the structure of the multi-level converter 41 in order to minimise the number of converter components in the multi-level converter 41, whilst enabling connection of the power electronic converter assembly 40 to the three-phase AC network.

A power electronic converter assembly 140 according to a second embodiment of the invention is shown in FIG. 6. The second power electronic converter assembly 140 of FIG. 6 is similar in structure and operation to the first power electronic converter assembly 40 of FIG. 3 and like features share the same reference numerals.

The second power electronic converter assembly 140 differs from the first power electronic converter assembly 40 in that each limb portion 52,54 of the primary converter limb 48 further includes a primary switching block 82 connected in series with the primary voltage source 56, and each limb portion 52,54 of each secondary converter limb 50 further includes a secondary switching block 84 connected in series with the secondary voltage source 64.

Each switching block 82,84 includes a plurality of series-connected auxiliary switching elements 86. Each auxiliary switching element 86 is constituted by a semiconductor device in the form of an Insulated Gate Bipolar Transistor (IGBT), and includes an anti-parallel diode 70 connected in parallel therewith.

The number of auxiliary switching elements 86 in each switching block 82,84 may vary, depending on the required voltage rating of each limb portion 52,54.

The series connection between the switching block 82,84 and the voltage source 56,64 in each limb portion 52,54 allows, in other embodiments of the invention, the switching block 82,84 and the voltage source 56,64 to be connected in a reverse order between the corresponding AC terminal 46 and the respective first or second DC terminal 42a,42b.

In the second power electronic converter assembly 140, the controller 80 varies the timing of switching operations of the modules 58,66 of each voltage source 56,64 and the switching blocks 82,84 to generate a AC phase voltage VA, VB, VC at each corresponding AC terminal 46 using a step-wise approximation.

In particular, in each converter limb 48,50, the controller 80 switches the modules in the first limb portion 52 to generate a first AC phase voltage component, and switches the modules in the second limb portion 54 to generate a second AC phase voltage component. Meanwhile the controller 80 switches each switching block 82,84 on and off to dictate the switching of each limb portion 52,54 into or out of circuit with the corresponding AC terminal 46 and thereby controls the combination of the first and second phase voltage components to generate an AC phase voltage VA, VB, VC at each AC terminal 46.

The switching of each limb portion 52,54 into or out of circuit with the corresponding AC terminal 46 is carried out when the AC terminal current passes zero, which results in almost zero switching losses during operation of the second power electronic converter assembly 140. In addition, the modules 58,66 in each voltage source 56,64 may be switched to offset the DC voltage at the first or second DC terminal 42a,42b. As a result, there is zero or minimal voltage across each switching block 82,84 when it switches from one state to the other. The zero or minimal voltage across each switching block 82,84 leads to low switching losses.

The switching of each limb portion 52,54 into or out of circuit with the corresponding AC terminal 46 also reduces the voltage range that each voltage source 56,64 would be required to generate, without affecting the ability of the second power electronic converter assembly 140 to generate AC phase voltages VA, VB, VC that are identical to that generated by the first power electronic converter assembly 40.

Thus, as shown in FIG. 6, when each switching block 82,84 is configured to have a voltage rating of 1.0 per unit voltage, each primary voltage source 56 in the primary converter limb 48 is configured to have a voltage rating of 1.732 per unit voltage, and each secondary voltage source 64 in the secondary converter limbs 50 is configured to have a voltage rating of 1.0 per unit voltage. This results in a reduced number of modules 58,66 in the second power electronic converter assembly 140 in comparison to the first power electronic converter assembly 40, which results in further savings in terms of numbers of switching elements 60,68 and capacitors 62.

The use of a switching block 82,84 in each limb portion 52,54 therefore not only results in a more efficient and reliable power electronic converter assembly 140, but also results in a smaller, lighter and cheaper power electronic converter assembly 140.

A power electronic converter assembly 240 according to a third embodiment of the invention is shown in FIG. 7. The third power electronic converter assembly 240 of FIG. 7 is similar in structure and operation to the second power electronic converter assembly 140 of FIG. 6 and like features share the same reference numerals.

The third power electronic converter assembly 240 differs from the second power electronic converter assembly 140 in that
each limb portion 52,54 of each secondary converter limb 50 includes a secondary switching block 84, but omits the secondary voltage source 64;
the secondary converter limbs 50 are connected in parallel between the first and second DC terminals 42a,42b; and
the multi-level converter 41 further includes two secondary voltage sources 64, each secondary voltage source 64 extending between: the parallel connection of the secondary converter limbs 50; and a respective one of the first and second DC terminals 42a,42b.

Each secondary voltage source 64 is in the form of a unidirectional voltage sub-source.

As in the second power electronic converter assembly 140, the controller 80 switches the first modules 58 in the primary converter limb 48 and switches the primary switching blocks 82 so as to generate a first, sinusoidal AC phase voltage VA with an amplitude of 1.732 per unit voltage and a phase angle of zero degrees.

Meanwhile the controller 80 switches the modules 66 in each secondary voltage source 64 and switches the secondary switching blocks 84 on and off in diagonal pairs to dictate the switching of each limb portion 52,54 in and out of circuit with the corresponding AC terminal 46. This results in the generation of an AC phase voltage VBC across the AC terminals 46 of the secondary converter limbs 50, whereby VBC is a sinusoidal AC phase voltage that has an amplitude of 2.0 per unit voltage and is displaced by 90 electrical degrees relative to the first AC phase voltage VA. This results in the set of asymmetrical voltage vectors shown in FIG. 5, in which each of VB and VC oscillates between +1.0 per unit voltage and −1.0 per unit voltage.

The configuration of the multi-level converter 41 in this manner further reduces the overall number of voltage sources 56,64, which enables further savings in terms of overall size, weight and cost, without affecting the capability of the multi-level converter 41 to synthesise a set of asymmetrical voltage vectors that results in a balanced load/source for presentation to the three-phase AC network.

A power electronic converter assembly 340 according to a fourth embodiment of the invention is shown in FIG. 8. The fourth power electronic converter assembly 340 of FIG. 8 is similar in structure and operation to the third power electronic converter assembly 240 of FIG. 7 and like features share the same reference numerals.

The fourth power electronic converter assembly 340 differs from the third power electronic converter assembly 240 in that, in the fourth power electronic converter assembly 340, each secondary voltage source 64 further includes a bidirectional voltage sub-source connected in series with the corresponding unidirectional voltage sub-source. In addition, in the fourth power electronic converter assembly 340, the controller 80 switches the modules 58,66 in the bidirectional and unidirectional voltage sub-sources, and switches the secondary switching blocks 84 on and off to dictate the switching of each limb portion 52,54 in and out of circuit with the corresponding AC terminal 46, in order to generate the AC phase voltage VBC across the AC terminals 46 of the secondary converter limbs 50.

A fault or other abnormal operating condition in the DC network may lead to a short-circuit 88 occurring across the DC network. This results in the DC voltages at the first and second DC terminal 42a,42b dropping to zero volts. When this happens, a high fault current can flow from the AC network through a current path defined by the converter limbs 48,50 and the short-circuit 88.

The low impedance of the short-circuit 88 means that the fault current flowing through the current path may exceed the current rating of the multi-level converter 41.

The fault current may be minimised by opposing an AC driving voltage from the AC network. This is carried out by configuring the fourth power electronic converter assembly 340 in a fault operating mode, in which the first switching elements 60 of the first modules 58 of each bidirectional voltage sub-source are switched so that each first module 58 provides a voltage VO which opposes and thereby reduces the driving voltage. Each bidirectional voltage sub-source is capable of providing a positive or negative opposing voltage VO and is thereby suitable to oppose the AC driving voltage.

The use of the bidirectional voltage sub-sources in the secondary voltage sources 64 to oppose the AC driving voltage permits charging of each first module 58 of these bidirectional voltage sub-sources so as to restore its capacitor 62 to a desired voltage level.

In contrast, the use of a unidirectional voltage sub-source in each secondary voltage source 64 of the first, second and third power electronic converter assemblies 40,140,240 means that the secondary converter limbs 50 would not be able to oppose the AC driving voltage. Instead, the secondary converter limbs 50 would remain in diode conduction during the short-circuit 88 across the DC network, which increases the risk of damage to the converter components of the first, second and third power electronic converter assemblies 40,140,240.

The use of a bidirectional voltage sub-source in each secondary voltage source 64 therefore improves the reliability of the fourth power electronic converter assembly 340.

A power electronic converter assembly 440 according to a fifth embodiment of the invention is shown in FIG. 9. The fifth power electronic converter assembly 440 of FIG. 9 is similar in structure and operation to the fourth power electronic converter assembly 340 of FIG. 8 and like features share the same reference numerals.

The fifth power electronic converter assembly 440 differs from the fourth power electronic converter assembly 340 in that, in the fifth power electronic converter assembly 440, each secondary voltage source 64 includes the bidirectional voltage sub-source, but omits the unidirectional sub-source. In addition, in the fifth power electronic converter assembly 440, the controller 80 switches the first modules 58 in the bidirectional voltage sub-sources, and switches the secondary switching blocks 84 on and off to dictate the switching of each limb portion 52,54 in and out of circuit with the corresponding AC terminal 46, to generate the AC phase voltage VBC across the AC terminals 46 of the secondary converter limbs 48,50.

A fault operating mode of the fifth power electronic converter assembly 440 is similar to the fault operating mode of the fourth power electronic converter assembly 340, except that the use of the bidirectional voltage sub-sources in the secondary voltage sources 64 to oppose the AC driving voltage does not require charging of the first modules 58 of these bidirectional voltage sub-sources.

A power electronic converter assembly 540 according to a sixth embodiment of the invention is shown in FIG. 10.

The sixth power electronic converter assembly 540 comprises a multi-level converter 41 including three auxiliary terminals 100, and three AC terminals 46.

In use, each auxiliary terminal 100 is connected to ground 102.

The multi-level converter 41 further includes a primary converter limb 48 and two secondary converter limbs 50. Each converter limb 48,50 includes a respective one of the auxiliary terminals 100, and a respective one of the AC terminals 46. Each converter limb 48,50 extends between its auxiliary terminal 100 and its AC terminal 46.

The primary converter limb 48 includes a primary voltage source 56 in the form of a first bidirectional voltage sub-source. Each secondary converter limb 50 includes a secondary voltage source 64 in the form of a second bidirectional voltage sub-source. Each of the first and second bidirectional voltage sub-sources is similar in structure and operation to the each bidirectional voltage sub-source shown in FIG. 3, but the number of first modules 58 in the first bidirectional voltage sub-source is higher than the number of first modules 58 in each second bidirectional voltage sub-source.

Each primary voltage source 56 is configured to have a voltage rating of 1.732 per unit voltage, while each secondary voltage source 64 is configured to have a voltage rating of 1.0 per unit voltage.

The sixth power electronic converter assembly 540 further includes three phase elements 72 defining a star connection. A first end of each phase element 72 is connected to a common junction of the star connection, while each secondary AC terminal 46 is connected in series with a second end of a respective phase element 72 of the star connection. Each phase element 72 is in the form of a transformer secondary winding.

In use, each phase element 72 is coupled to a respective transformer primary winding 104 and the plurality of transformer primary windings 104 are connected in a star configuration for connection to a three-phase AC network 106.

The sixth power electronic converter assembly 540 further includes a controller 80 to switch the multi-level converter 41 to generate and modulate an AC phase voltage at each AC terminal 46.

In particular, the controller 80 varies the timing of the switching operations of the first modules 58 in each voltage source 56,64 to generate an AC phase voltage at each AC terminal 46 using a step-wise approximation, in the same manner as the controller 80 of the first power electronic converter assembly 40 shown in FIG. 3.

In use, the controller 80 is therefore able to selectively switch the IGBTs 60 of the first modules 58 in each voltage source 56,64 to vary the voltage across each voltage source 56,64 and thereby modulate the AC phase voltage VA, VB, VC at each AC terminal 46.

In this manner, the first modules 58 in the primary converter limb 48 are switched to generate a first, sinusoidal AC phase voltage VA with an amplitude of 1.732 per unit voltage and a phase angle of zero degrees at the corresponding AC terminal 46, and the first modules 58 in each secondary converter limb 50 are switched to generate a second, sinusoidal AC phase voltage VB with an amplitude of 1.0 per unit voltage and a phase angle of 90 degrees; and a third, sinusoidal AC phase voltage VC with an amplitude of 1.0 per unit voltage and a phase angle of −90 degrees at the corresponding AC terminal 46, as shown in FIGS. 5 and 10.

The three AC phase voltages VA, VB, VC define a set of asymmetrical voltage vectors, which results in a sinusoidal neutral point voltage VN with an amplitude of 0.577 per unit voltage and a phase angle of zero degrees, and symmetrical line-to-neutral voltages VAN, VBN, VCN, each with a magnitude of 1.155 per unit voltage and separated by 120 electrical degrees from the other two line-to-neutral voltages, as shown in FIG. 5. These symmetrical line-to-neutral voltage characteristics therefore enable the sixth power electronic converter assembly 540 to present a balanced load/source for connection to the three-phase AC network 106 via the transformer primary windings 104.

In this manner, the sixth power electronic converter assembly 540 is able to be used as a static synchronous compensator.

It is envisaged that, in other embodiments of the invention, the multi-level converter of the power electronic converter assembly may be or may include a neutral point diode clamped converter or a flying capacitor converter.

In other embodiments of the invention, it is envisaged that the power electronic converter assembly may be configured and operated to present a balanced load/source to a multi-phase AC network or load having more than three phases. Such a power electronic converter assembly includes a plurality of AC terminals and a plurality of phase elements, each of which corresponds in number to the number of AC phases in the multi-phase AC network or load.

1-13. (canceled)

14. A power electronic converter assembly comprising:
a multi-level converter including a plurality of AC terminals, the multi-level converter being operable to generate an AC phase voltage (V_{A}, V_{B}, V_{C}) at each AC terminal;
a plurality of phase elements defining a star connection in which a first end of each phase element is connected to a common junction, each AC terminal being connected in series with a second end of a respective phase element of the star connection; and
a controller to switch the multi-level converter to modulate the plurality of AC phase voltages (V_{A}, V_{B}, V_{C}) to define a set of asymmetrical voltage vectors so as to synthesise a non-zero neutral point voltage at the common junction of the star connection, the non-zero neutral point voltage and each AC phase voltage (V_{A}, V_{B}, V_{C}) defining a line-to-neutral voltage across each phase element, the line-to-neutral voltages being equal in magnitude and displaced at equidistant phase angles,
first and second DC terminals for connection to a DC network, the multi-level converter being operable to generate a DC voltage at the first and second DC terminals; and
a plurality of converter limbs, each converter limb extending between the first and second DC terminals and including a respective one of the AC terminals, the plurality of converter limbs including at least one primary converter limb and at least one secondary converter limb, each converter limb including first and second limb portions separated by the corresponding AC terminal, each limb portion of the primary converter limb including a primary voltage source in the form of a bidirectional voltage sub-source and each limb portion of the secondary converter limb including a secondary voltage source in the form of a unidirectional voltage sub-source.

15. A power electronic converter assembly according to claim 14, wherein the multi-level converter includes three AC terminals and the controller switches the multi-level converter to modulate each AC phase voltage to generate:
a first, sinusoidal AC phase voltage with an amplitude of 1.732 per unit voltage and a phase angle of zero degrees,
a second sinusoidal AC phase voltage with an amplitude of 1.0 per unit voltage and a phase angle of 90 degrees,
and a third, sinusoidal AC phase voltage with an amplitude of 1.0 per unit voltage and a phase angle of −90 degrees.

16. A power electronic converter assembly according to claim 14, wherein each limb portion of the or each primary converter limb further includes a primary switching block connected in series with the corresponding voltage source, and each limb portion of the or each secondary converter limb further includes a secondary switching block connected in series with the corresponding voltage source.

17. A power electronic converter assembly comprising:
a multi-level converter including a plurality of AC terminals, the multi-level converter being operable to generate an AC phase voltage (V_{A}, V_{B}, V_{C}) at each AC terminal;
a plurality of phase elements defining a star connection in which a first end of each phase element is connected to a common junction, each AC terminal being connected in series with a second end of a respective phase element of the star connection; and
a controller to switch the multi-level converter to modulate the plurality of AC phase voltages (V_{A}, V_{B}, V_{C}) to define a set of asymmetrical voltage vectors so as to synthesise a non-zero neutral point voltage at the common junction of the star connection, the non-zero neutral point voltage and each AC phase voltage (V_{A}, V_{B}, V_{C}) defining a line-to-neutral voltage across each phase element, the line-to-neutral voltages being equal in magnitude and displaced at equidistant phase angles,
first and second DC terminals for connection to a DC network, the multi-level converter being operable to generate a DC voltage at the first and second DC terminals; and
a plurality of converter limbs, each converter limb extending between the first and second DC terminals and including a respective one of the AC terminals, the plurality of converter limbs including one primary converter limb and two secondary converter limbs, the secondary converter limbs being connected in parallel between the first and second DC terminals, each converter limb including first and second limb portions separated by the corresponding AC terminal, each first and second limb portion of the primary converter limb including a primary switching block in series with a primary voltage source in the form of a bidirectional voltage sub-source and each first and second limb portion of each secondary converter limb including a secondary switching block in series with a secondary voltage source in the form of a unidirectional voltage sub-source, said secondary voltage source being shared by the two secondary converter limbs.

18. A power electronic converter assembly comprising:
a multi-level converter including a plurality of AC terminals, the multi-level converter being operable to generate an AC phase voltage (V_{A}, V_{B}, V_{C}) at each AC terminal;
a plurality of phase elements defining a star connection in which a first end of each phase element is connected to a common junction, each AC terminal being connected in series with a second end of a respective phase element of the star connection; and
a controller to switch the multi-level converter to modulate the plurality of AC phase voltages (V_{A}, V_{B}, V_{C}) to define a set of asymmetrical voltage vectors so as to synthesise a non-zero neutral point voltage at the common junction of the star connection, the non-zero neutral point voltage and each AC phase voltage (V_{A}, V_{B}, V_{C}) defining a line-to-neutral voltage across each phase element, the line-to-neutral voltages being equal in magnitude and displaced at equidistant phase angles,
a plurality of auxiliary terminals, each auxiliary terminal being for connection to ground; and
a plurality of converters limbs, each converter limb including a respective one of the auxiliary terminals and a respective one of the AC terminals, each converter limb extending between its auxiliary terminal and its AC terminal,
wherein the plurality of converter limbs includes a primary converter limb and two secondary converter limbs, each primary converter limb including a primary voltage source in the form of a bidirectional voltage sub-source and each secondary converter limb including a secondary voltage source in the form of a bidirectional voltage sub-source.

19. A power electronic converter assembly according to claim 14, wherein each voltage sub-source includes at least one module, the or each module including: at least one energy storage device; and at least one switching element to selectively direct current through the or each energy storage device and cause current to bypass the or each energy storage device.

20. A power electronic converter assembly according to claim 14, wherein each bidirectional voltage sub-source includes at least one first module, the or each first module including two pairs of first switching elements connected in parallel with an energy storage device in a full-bridge arrangement to define a 4-quadrant bipolar module that can provide negative, zero or positive voltage and can conduct current in two directions.

21. A power electronic converter assembly according to claim 14, wherein each unidirectional voltage sub-source includes at least one second module, the or each second module including a pair of second switching elements connected in parallel with an energy storage device in a half-bridge arrangement to define a 2-quadrant unipolar module that can provide zero or positive voltage and can conduct current in two directions.

22. A power electronic converter assembly according to claim 14, wherein the multi-level converter is or includes a neutral point diode clamped converter or a flying capacitor converter.

23. A power electronic converter assembly according to claim 17, wherein each voltage sub-source includes at least one module, the or each module including: at least one energy storage device; and at least one switching element to selectively direct current through the or each energy storage device and cause current to bypass the or each energy storage device.

24. A power electronic converter assembly according to claim 17, wherein each bidirectional voltage sub-source includes at least one first module, the or each first module including two pairs of first switching elements connected in parallel with an energy storage device in a full-bridge arrangement to define a 4-quadrant bipolar module that can provide negative, zero or positive voltage and can conduct current in two directions.

25. A power electronic converter assembly according to claim 17, wherein each unidirectional voltage sub-source includes at least one second module, the or each second module including a pair of second switching elements connected in parallel with an energy storage device in a half-bridge arrangement to define a 2-quadrant unipolar module that can provide zero or positive voltage and can conduct current in two directions.

26. A power electronic converter assembly according to claim 18, wherein each voltage sub-source includes at least one module, the or each module including: at least one energy storage device; and at least one switching element to selectively direct current through the or each energy storage device and cause current to bypass the or each energy storage device.

27. A power electronic converter assembly according to claim 18, wherein each bidirectional voltage sub-source includes at least one first module, the or each first module including two pairs of first switching elements connected in parallel with an energy storage device in a full-bridge arrangement to define a 4-quadrant bipolar module that can provide negative, zero or positive voltage and can conduct current in two directions.

28. A power electronic converter assembly according to claim 18, wherein each unidirectional voltage sub-source includes at least one second module, the or each second module including a pair of second switching elements connected in parallel with an energy storage device in a half-bridge arrangement to define a 2-quadrant unipolar module that can provide zero or positive voltage and can conduct current in two directions.
